(19) United States
(12) Patent Application Publication
(10) Pub. No.: US 2009/0171694 A1
(43) Pub. Date: Jul. 2, 2009

(54) SYSTEM FOR MANAGING LABORATORY TEST RESULTS FOR PATIENTS TAKING AN ENDOTHELIN RECEPTOR ANTAGONIST

(76) Inventors: Ernest Osgood Ross III, San Francisco, CA (US); Eugenia Anatoly Rutenberg, Redwood City, CA (US); Martin Barrett Grossman, Basel (CH); Patrick Shaughnessy Malloy, Naperville, IL (US)

Correspondence Address: MICHAEL BEST & FRIEDRICH LLP, ONE SOUTH PINCKNEY STREET, P O BOX 1806, MADISON, WI, 53701, US

(21) Appl. No.: 11/967,441

(22) Filed: Dec. 31, 2007

(51) Int. Cl. G06Q 50/00

(52) U.S. Cl. 705/3

(57) ABSTRACT

The invention provides a system and method of collecting, storing and managing laboratory test results of patients. In one embodiment the invention is directed towards collecting, storing and managing laboratory test results of patients taking an endothelin receptor antagonist (ERA). The system provides a way of securely collecting and tracking information from a plurality of patients, a plurality of laboratories, and a plurality of health care providers by use of a database. The method comprises receiving patient information from health care providers, receiving a laboratory test schedule for each patient, and laboratory tests needed for each patient. This data is entered into a central processing computer. The patients then go to any laboratory to have the monthly testing done due to the ERA prescription. The laboratory test data collected is sent to the central processing computer. The central processing computer can generate an automated report on the laboratory results and supply the results to the health care provider. Additionally, if no laboratory test data for the patient is entered into the central processing computer in accordance with the laboratory test schedule for the patient, the central processing computer will notify a call center which will call the patient, laboratory or health care provider informing them of the overdue laboratory test data.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

Endothelin is a powerful vasoconstrictor peptide derived from the endothelium. Because of its powerful vasoconstrictor properties, endothelin has been implicated in the pathogenesis of hypertension, coronary vasospasm, and heart failure. An endothelin receptor antagonist (ERA) is a drug which blocks endothelin receptors, and can be used to treat endothelin related disorders, e.g., pulmonary arterial hypertension.

One problem with ERAs is that they can cause liver damage to patients, as well as birth defects in gestating fetuses. As a result of these potentially serious side effects, patients prescribed ERAs must have at least monthly laboratory tests performed to monitor, amongst other things, their liver function and, if the patient is female and of childbearing potential, a test for pregnancy. As many patients taking ERAs are outpatients, the frequent laboratory testing presents a burden on the patient as it is often difficult to fit the required testing into a patient's life and travel schedule. This frequent testing also presents a high level of patient management for health care providers, as they need to locate the tests for all the patients, review the frequent tests and ensure patients are in compliance with the required testing regimen.

Patients are required to travel to a laboratory or health care provider so the monthly laboratory work can be done. The health care provider must monitor the compliance of the patient to the testing regimen and directly follow up with the patient if they fail to meet the regimen. Such monitoring methods, therefore, places time burdens on both the patients and the health care provider, and cost burdens on the health care provider to monitor the compliance of the patients.

### SUMMARY OF THE INVENTION

The invention provides a method of collecting, storing and managing laboratory test results for patients taking an endothelin receptor antagonist (ERA). The method provides internet webpage-based access to the laboratory test data for the health care providers who are handling the care of patients prescribed an ERA. The method includes a central processing center for collecting, storing and processing patient information, an automated alert system and a call center.

In the method of the invention, a health care provider who prescribes an ERA to a patient, has the patient, or a patient representative, sign a privacy waiver to allow for the transmission of the patient's health information. The patient, the patient representative or the health care provider completes the privacy waiver and provides the executed waiver to the central processing center. Medical and biographical information on the patient is also provided to the central processing center. These data are entered into a central processing computer having a database system that associates the patient data with the specific health care provider. For each patient, the health care provider also provides the central processing center with a laboratory test schedule. These data are also entered into the database system. The health care provider provides laboratory test forms to the laboratory of the patient's choice or to the patient directly who may take the forms to any laboratory to have the testing done. The laboratory collects the necessary samples from the patient and generates laboratory test results for the patient. The laboratory then sends the test data to the central processing center where the test data is entered into the central processing computer and associated with the patient who was tested.

In one embodiment, the central processing computer either can send a regularly scheduled report to the health care provider with the test data for the patient, provide the test data to the health care provider as soon as it is received, or simply send a notice to the health care provider that new data is available for the patient. Alternatively, the health care provider can access the patient data via an internet website interface that communicates with the central processing computer.

In another aspect, if the central processing method has not received test data for a patient in accordance with the laboratory schedule for the patient, the central processing computer has an automated alert feature which notifies a call center to call either 1) the laboratory to inquire about the missing data; 2) the patient to inquire about the missing data; 3) the health care provider to inform them of the missing data, or; 4) all or any combination of the laboratory, patient and health care provider.

### BRIEF DESCRIPTION OF THE DRAWINGS

FIG. 1 is a process flow diagram that illustrates one embodiment of the system of the invention.

FIG. 2 is a process flow diagram that illustrates one embodiment of the system of the invention.

FIG. 3 is a process flow diagram showing one embodiment of the reporting process of the central processing computer of the invention.

FIG. 4 is a process flow diagram showing one embodiment of a reporting pathway of the central processing computer of the invention.

### DETAILED DESCRIPTION OF THE INVENTION

Before the embodiments of the invention are explained in detail, it is to be understood that the invention is not limited in its application to the details of the arrangements of the components set forth in the following description or illustrated in the drawings. The invention is capable of other embodiments and of being practiced or being carried out in various ways. Also, it is understood that the phraseology and terminology used herein are for the purpose of description and should not be regarded as limiting. The use of “including,” “comprising,” or “having,” and variations thereof herein are meant to encompass the items listed thereafter and equivalents thereof, as well as additional items and equivalents thereof.

The invention provides a system and method of collecting, storing and managing laboratory test results of patients. In one embodiment the invention is directed towards collecting, storing and managing laboratory test results of patients taking an ERA. The system provides a way of securely collecting and tracking information from a plurality of patients, a plurality of laboratories, and a plurality of health care providers by use of a database. The method allows for the communication of data from patients, health care providers, and laboratories to a central processing center which organizes the data by way of a central processing computer, and coordinates the flow of information through the computer which can be accessed through an internet webpage interface and by way of a call center.

The term “health care providers” as used herein means any health organization that has physician or other members or employees that treat patients. Health care providers include, but are not limited to, hospitals, health maintenance organizations (HMOs), physician practice groups, or individual physician, nurse, nurse practitioner, or physicians assistant (PAs) practices. The term “plurality of health care providers” and “plurality of laboratories” means more than one health care provider or laboratory respectively, wherein each of the health care providers or laboratory in the “plurality” are separate business entities from the other. Health care providers, thus, can be any appropriate providers for treating patients requiring an ERA. Laboratories can be any laboratory appropriate for performing the required tests.

The central processing center is also a separate business entity from the health care provider and/or the laboratory. By “separate business entity” it is meant that the central processing center (or health care provider or laboratory) is a separate business organization, having different individuals or companies in control of the organization than the health care provider and/or laboratory entities. The central processing center can have a physical address at one location, or at multiple locations. In other words, laboratories and health care providers are not affiliated with, employed by or in any way associated with the separate business entity of the system of the invention except for access to the system for tracking patient laboratory results.

As the central processing center is a separate business entity from the health care provider, the health care provider entity does not have to bear the cost and/or time burden of managing the coordination of laboratory results, and patient compliance with testing regimens, of patients taking an ERA. This provides a significant benefit to the health care provider. In one embodiment of the invention, the services of the central processing center are provided as a value-added service for a specific brand of ERA, i.e., the services are provided to the patient and the health care provider without cost, or at discounted cost

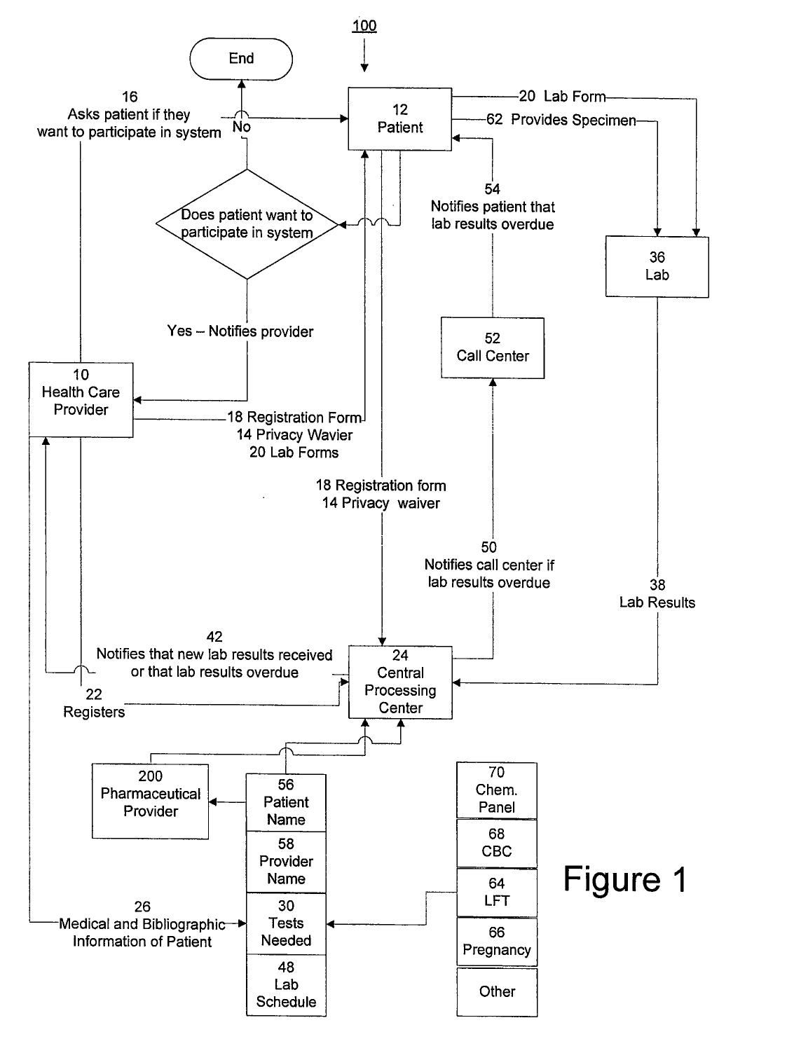

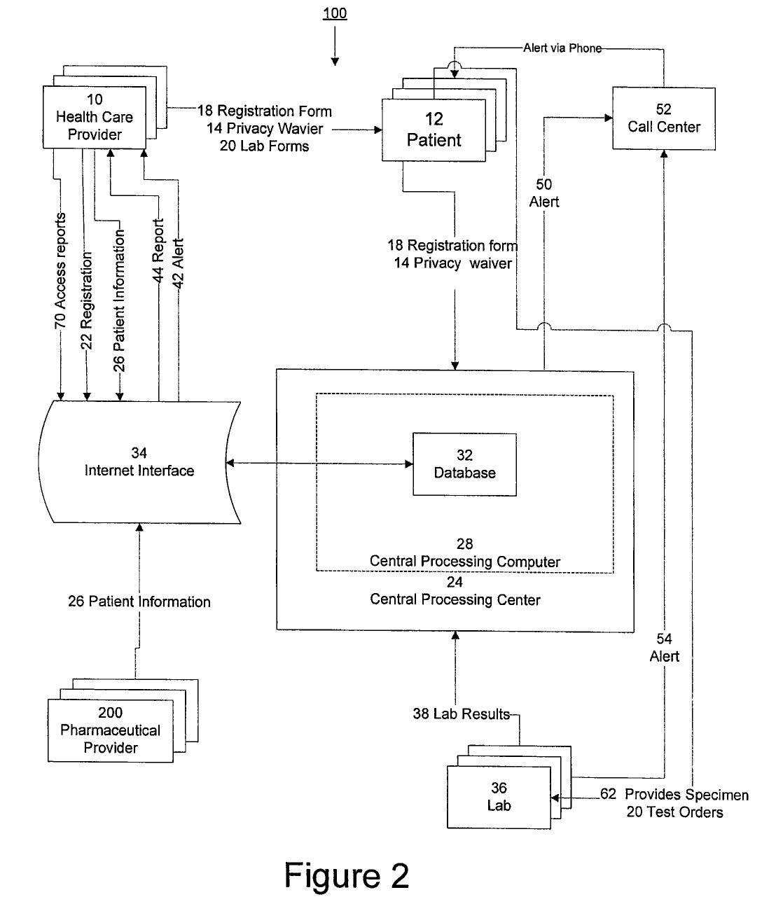

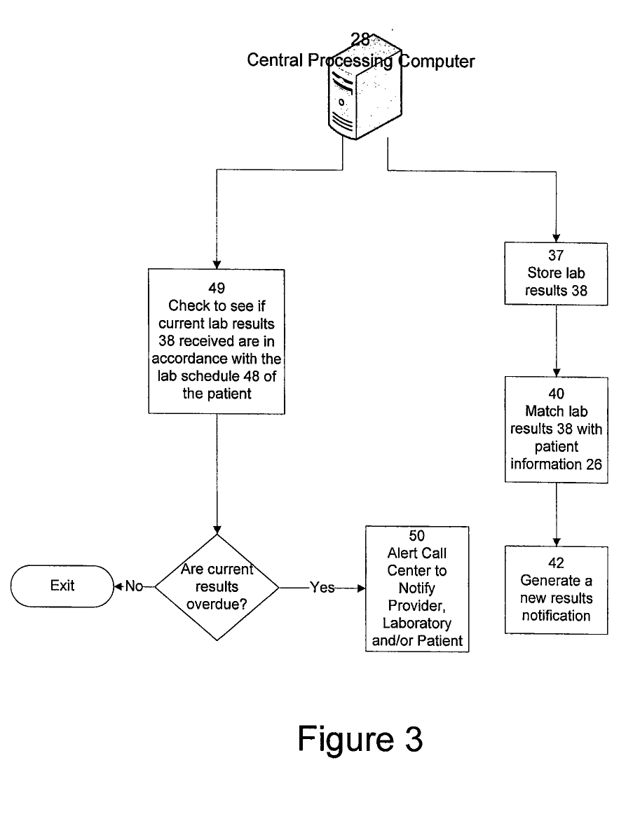

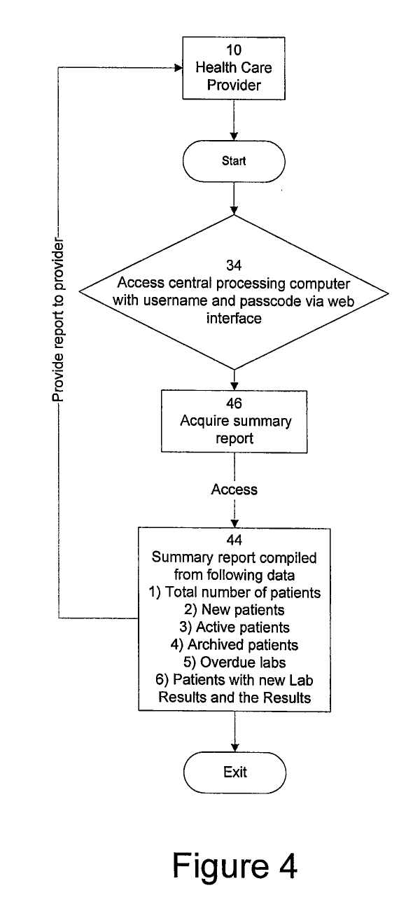

FIGS. 1 to 4 illustrate the features and functions of one embodiment of a laboratory tracking system, designated generally as reference numeral 100, in accordance with the invention. To begin, a health care provider 10 who is prescribing an ERA to a patient 12, provides to the patient 12 an appropriate privacy form 14 (e.g. a Health Insurance Portability and Accountability Act (HIPAA) waiver) to allow for the transmission of the patient's health information. In an alternative embodiment, not shown, the health care provider can instruct the central processing center to provide the privacy form to the patient. The health care provider 10, in step 16 receives the patient's acceptance to use the system. In an alternative embodiment, not shown, the patient can indicate their acceptance to use the system directly to the central processing center. The health care provider 10 then provides the patient a registration form 18 for the laboratory tracking system 100, and laboratory order forms 20 providing the laboratory tests needed for the patient 12. In an alternative embodiment, not shown, the health care provider can provide the laboratory order forms directly to a laboratory of the patient's choice. Also, the registration form can be sent to the patient by the central processing center by the request of the health care provider.

At step 22, the health care provider 10 then registers with the central processing center 24. In another embodiment, not shown, the patient can directly register with the central processing system or with the health care provider who subsequently provides the information to the central processing center. In one embodiment, the health care provider 10 provides the central processing center 24 with medical and bibliographic information 26 on the patient 12. In another embodiment, the medical and bibliographic information 26 is provided to the central processing center by a pharmaceutical provider 200 (e.g. a pharmaceutical company or pharmacy) which provides the prescribed drug to the patient, who has the medical and bibliographic information on file for the patient. This patient information 26 can include a patient identifier 56 (such as the patient's name, social security number or other patient identifier indicia), a health care provider identifier 58 (such as the health care providers name or tax ID number), the laboratory tests 30 needed for the patient, a laboratory testing schedule 48 for the patient 12, and any other relevant information. These data are entered into a central processing computer 28 having a database system 32 that associates the patient information 26 with the specific health care provider 10. The term “central processing computer” means either a single computer, or a series of computers connected together in either a local area network (LAN), or an intranet network. The database 32 program and data can be stored on any acceptable electronic storage media, such as a hard drive, connected to the central processing computer 28. Any standard commercially available database program can be used to create the database 32. The central processing computer 28 is also connected to the internet. The patient information 26 can either be sent to the central processing center 24 manually (e.g. by fax, mail or email), or it can be entered into the central processing computer 28 database 32 directly through an internet webpage interface 34 by health care providers as described below. Any information received, entered into, or provided to the central processing computer 28 either directly, or through the webpage interface 34 is considered as being received or provided to central processing center 24 or entered by the central processing center 24. When the patient information 26 is provided manually, it is received by the central processing center 24 and then entered into the central processing computer 28 database 32 by a data entry specialist. When the patient information 26 is provided through the internet webpage interface 34, each health care provider 10 is given a unique username and password that uniquely identifies the health care provider 10 accessing the computer 28. Such identification can be used to limit the health care provider's 10 access strictly to information related to the provider's patients 12.

The patient 12 provides the signed privacy waiver form 14 and registration form 18 to the central processing center 24, and these documents are associated with the patients 12. In an alternative embodiment, not shown, the patient can provide the signed privacy waiver and registration form to the health care provider which can forward them on to the central processing center.

The patient 12 may then go to any laboratory 36, provide the laboratory test orders 20, the necessary specimens 63 (e.g. blood, urine, etc.) and have the testing performed. Patients 12 on an ERA require at least a monthly liver function test 64, and if the patient is female and of childbearing potential, a pregnancy test 66. Other tests which are often required for ERA patients are a complete blood count 68 and a chemistry panel 70.

Once the patient 12 goes to his or her selected laboratory 36, he/she provides the laboratory 36 with the laboratory test orders 20 and has the necessary tests conducted. In alternative embodiment, the test orders can be provided to the laboratory, selected by the patient, by the health care provider. Once the laboratory 36 has laboratory test results (or laboratory test data) 38, it submits the results 38 to the central processing center 24. The laboratory data 38 can be sent to the central processing center 24 in three different ways. In one embodiment, the laboratory data 38 is sent manually (e.g., by mail, fax or email) to the central processing center 24 and entered into the central processing computer 28 database 32 by a data entry specialist working at the center. In another embodiment, the laboratory data 38 is entered into the central processing computer 28 database 32 directly through a password protected internet webpage interface 34. In yet another embodiment, the laboratory data 28 is downloaded directly to the central processing computer 28 from the laboratory's 36 computer system. At step 37, the central processing computer 28 database 32 stores the recorded laboratory test data 38 and in step 40 associates data 38 with the patient information 26 for a patient 12.

The central processing computer 28 is programmed to track the recorded patient information 26 and laboratory data 38 and perform certain actions depending on the data 26, 38. In one embodiment, when new laboratory results 38 are received for a patient 12, the computer 28 sends an automated notification email 42 to the health care provider 10 that new laboratory results 38 are available for the patient 12. At step 46, the health care provider 10 can then access the central processing computer 28 via a password protected internet webpage access point 34 and gain access to the laboratory results 38. The laboratory test results 38 can be provided to the health care provider 10 via a custom generated webpage that provides real-time information on all patients 12 associated with the health care provider 10. In other embodiments, the laboratory results 38 can be transmitted to the health care provider either by e-mail or by direct download to the health care provider's own patient database system.

In a further embodiment, the central processing computer 28 can also be programmed to generate a summary report 44, listing the test data 38 for all patients 12 associated with a particular health care provider 10. This report 44 can be generated on any specific repeatable time basis, and can be provided to the health care provider 10 in a variety of ways. In one embodiment, the report 44 is sent directly to the health care provider 10. This can be done by email or by a direct download to the computer system of the health care provider. In another embodiment, the report 44 is stored on the central processing computer 28. At step 46, the health care provider can access the central processing computer 28 via the password protected internet webpage interface 34 and obtain a copy of the report 44. In yet another embodiment, the central processing computer 28 can simply generate an email notice to the health care provider 10 that a new report 44 is ready, and the health care provider 10 can retrieve the report 44 through the internet webpage interface 34. In a further embodiment, such a summary report 44 can include a listing of the total number of patients registered, newly registered patients, patients currently still taking an ERA (active patients), patients no longer taking an ERA (archived patients), patients with overdue laboratory test results, patients with new laboratory test results and the test results for those patients. The report 44 can also contain a historical listing of all the previous test data 38 for a patient.

In another aspect, the central processing computer 28 can also be programmed to have an automated alert system. In the system, at step 49, the central processing computer 28 is programmed to check on a repeatable basis (e.g. daily, weekly, monthly) if laboratory data 38 for a patient 12 has been received by a date in accordance with the laboratory testing schedule 48 for the patient 12 (i.e. a deadline or deadline schedule for lab results provided in the schedule). If test data 38 for the patient 12 has not been received in accordance with the laboratory testing schedule 48, the central computer 28 sends a notification 50 to a call center 52 that the laboratory data 38 has not been supplied for the patient 12. The call center can be a separate business entity from the central processing center, or can be the same entity as the central processing center. This notification 50 can be an email to a call center specialist at the call center 52, or can be directly transmitted to a computer at the call center 52. The notification 50 can also contain the contact information for the patient 12. In one embodiment, the call center 52 then sends a call notification 54 to the patient 12 that the laboratory results 38 are overdue. In other embodiments, not shown, the call center can provide calls to the laboratory where the missing data should have been sent from, to determine the status of the missing data; or the call center can contact the health care provider of the patient, informing them of the missing test data. In other embodiments the call center can notify the patient, laboratory and the health care provider, or any combination of these parties. The call notification 54 can either be automated, with a computer dialing the contact information for the patient 12 and providing an automated message informing the patient of the missing laboratory test data, or the call center can be manual, with a call center specialist calling the patient 12 regarding the missing laboratory test data 38. The call center can also receive calls from the patient, health care provider, and laboratories and answer their calls regarding the laboratory test data 38, patient information 26, or any other data collected by the central processing center 24. The call center tracks and logs calls made to parties regarding missing laboratory information and provides this information to the central processing center. This call data is associated with the appropriate patient and can be accessed by healthcare providers associated with the patient.

In summary, the invention provides a centralized patient monitoring system for patients prescribed an ERA that 1) allows patients to utilize a plurality of laboratories to obtain the laboratory tests required for a patient taking an ERA; 2) provides the patient the decision making authority on which laboratory to use; 3) consolidates the test information for patients managed by a specific health care provider and provides the test information to the health care provider in a variety of formats; and 4) monitors patients to make sure they are compliant with the required testing regimen, and when they are not compliant with the regimen, utilizes a call center to remind the patient.

While the invention has now been described and exemplified with some specificity, those skilled in the art will appreciate the various modifications, including variations, additions, and omissions, that may be made in what has been described. Accordingly, it is intended that these modifications also be encompassed by the invention and that the scope of the invention be limited solely by the broadest interpretation that lawfully can be accorded the appended claims.

1. A method of collecting, storing and managing laboratory test data for patients taking an endothelin receptor antagonist, the method comprising:
i) providing patient information comprising patient identifier and information on a health care provider associated with the patient to a central processing center; the central processing center is a separate business entity from the health care provider;
ii) sending a privacy waiver to the patient; wherein the health care provider or the central processing center sends the privacy waiver;
iii) completing the privacy waiver, wherein the health care provider, patient or a patient representative completes the privacy waiver;
iv) sending the executed waiver to the central processing center;
v) entering the patient information into a central processing computer;
vi) providing the central processing center a laboratory test schedule for each patient, wherein the health care provider provides the laboratory test schedule;
vii) entering the laboratory test schedule into the central processing computer;
viii) providing laboratory tests forms to the patient, wherein the health care provider provides the laboratory test forms;
ix) visiting a laboratory, providing the laboratory test forms and having tests performed, resulting in laboratory test data for the patient, wherein the patient visits the laboratory, provides the laboratory test forms and has the test performed on them;
x) receiving the laboratory test data for the patient from the laboratory, wherein the central processing center receives the laboratory test data;
xi) entering the laboratory test data for the patient into the central processing computer;
xii) associating the laboratory test data with the patient that is the subject of the laboratory test data and the health care provider associated with the patient that is the subject of the laboratory data.

2. The method of claim 1 wherein if no laboratory test data for the patient is entered into the central processing computer in accordance with the laboratory test schedule for the patient, the central processing computer notifies a call center which calls the patient, laboratory, or the health care provider informing them that the laboratory test data is overdue.

3. The method of claim 1 wherein the health care provider receives a report from the central processing computer, the report providing:
i) names and laboratory test data for patients entered into the central processing computer associated with the health care provider;
ii) names of patients where no laboratory test data have been entered into the central processing computer in accordance with the laboratory test schedule for the patients, the patients being associated with the health care provider.

4. The method of claim 1 wherein laboratory test data received by the central processing center are received from a plurality of laboratories.

5. The method of claim 1 wherein patient information received by the central processing center is received from a plurality of health care providers.

6. A method of receiving and managing laboratory test results for patients taking an endothelin receptor antagonist, the method comprising a central processing center, which is a separate business entity from a health care provider, wherein the central processing center performs the following tasks:
i) receives patient information from the health care provider, the patient information comprising a patient identifier and a health care provider identifier for the health care provider associated with the patient;
ii) enters the patient information in a central processing computer;
iii) receives a laboratory schedule for each patient and laboratory tests needed for each patient from the health care provider;
iv) enters the laboratory test schedule and laboratory tests needed into the central processing computer;
v) receives laboratory test data for the patient from a laboratory, wherein the laboratory test data from the patient includes a liver function test;
vi) enters the laboratory test data for the patient into the central processing computer and associates the laboratory test data with the patient that is the subject of the laboratory test data and the health care provider associated with the patient;
wherein if no laboratory test data for the patient is entered into the central processing computer in accordance with the laboratory test schedule for the patient, the central processing computer notifies a call center which calls the patient, laboratory, or the health care provider informing them that the laboratory test data is overdue.

7. (canceled)

8. The method of claim 6 wherein the health care provider receives a report from the central processing computer, the report providing:
i) names and laboratory test data for patients entered into the central processing computer associated with the health care provider;
ii) names of patients where no laboratory test data has been entered into the central processing computer in accordance with the laboratory test schedule for the patients, the patients being associated with the health care provider.

9. The method of claim 6 wherein the central processing center performs the tasks for health care providers managing patients on a certain endothelin receptor antagonist, and performs the tasks at no charge to the health care provider.

10. A method of receiving and managing laboratory test results, comprising:
i) receiving patient information concerning one or more patients from one or more health care providers, the patient information for each patient comprising a patient identifier and a health care provider identifier for the health care provider associated with the patient;
ii) receiving a privacy waiver from the one or more patients;
iii) entering the patient information for each patient in a central processing computer;
iv) receiving for each patient a laboratory test schedule, and laboratory tests needed from the health care provider, and entering the laboratory test schedule and laboratory tests needed into the central processing computer;
v) receiving laboratory test data for each patient from a laboratory, wherein laboratory test data is received from a plurality of laboratories;
vi) entering the laboratory test data for each patient into the central processing computer;
vii) associating the laboratory test data with each patient that is the subject of the laboratory test data and the health care provider associated with the patient; and
viii) wherein if no laboratory test data for the patient is entered into the central processing computer in accordance with the laboratory test schedule for the patient, the central processing computer notifies a call center which calls the patient, laboratory, or the health care provider informing them that the laboratory test data is overdue.

11. The method of claim 10 wherein the health care provider receives a report from the central processing computer, the report providing:
i) names and laboratory test data for patients entered into the central processing computer associated with the health care provider;
ii) names of patients where no laboratory test data has been entered into the central processing computer in accordance with the laboratory test schedule for the patients, the patients being associated with the health care provider.
